(19) United States
(12) Patent Application Publication
(10) Pub. No.: US 2004/0199435 A1
(43) Pub. Date: Oct. 7, 2004

(54) Method and apparatus for remote location shopping over a computer network

(76) Inventors: David Hardin Abrams, Chicago, IL (US); Paul Randall Cooper, Evanston, IL (US); Michael Anton Halleen, Evanston, IL (US); Peter Nicholas Prokopowicz, Oak Park, IL (US)

Correspondence Address: MARK J. SPOLYAR, 38 FOUNTAIN ST., SAN FRANCISCO, CA, 94114, US

(21) Appl. No.: 10/824,733

(22) Filed: Apr. 15, 2004

Related U.S. Application Data
(63) Continuation-in-part of application No. 10/098,664, filed on Mar. 15, 2002, now Pat. No. 6,698,828.
(63) Continuation of application No. 09/363,246, filed on Jul. 28, 1999, now abandoned.

(51) Int. Cl. G06F 17/60

(52) U.S. Cl. 705/27

(57) ABSTRACT

Methods and systems for real-time shopping of a remote physical location over a computer network. The present invention integrates so-called “telepresence” systems with on-line, electronic commerce and merchandising systems to achieve a novel, real-time shopping experience. Unlike conventional on-line catalogs, the present invention allows the user to visually navigate in real-time within an actual, physical space in order to view physical objects located therein, and to select or identify such objects for purchase or further inspection. Users navigate through the physical space by viewing images captured by cameras located within the space and remotely controlling the cameras by means of a user interface to capture additional images of other selected regions within the space. According to the invention, the user interface of the present invention allows the user to identify or select viewed objects for purchase or further inquiry.

### FIELD OF THE INVENTION

The present invention relates to electronic commerce conducted over computer networks. More particularly, the present invention relates to methods and apparatuses that allow for shopping in an actual remote physical location over a computer network.

### BACKGROUND OF THE INVENTION

Advances in technology have often lead to revolutionary changes in economies and the marketplace for goods and services. Traditionally, consumers shopped for most retail items by traveling to physical store locations. Conventional specialty retail shops offered consumers a small, focused set of goods. Large retail chains, on the other hand, took advantage of economies of scale to give consumers access to a wider variety of goods, greater consistency, and lower prices than smaller retail stores. However, both small retail shops and large chain stores invested millions of dollars in and devoted great effort to the appearance and look-and-feel of their respective retail spaces and product displays, and product placement. The atmosphere of the store, as well as the environment in which products are displayed significantly influence the purchasing decision and, therefore, is quite important to the merchant.

The increased efficiency of mail package delivery and the widespread use and acceptance of credit spawned the rise of mail order sales. Mail order enabled shoppers to browse through catalogs and buy products without having to travel outside their homes. Mail order sales exposed consumers to a wider variety of products and to more information about each product. Later, television “infomercials” extended the mail order model, replacing catalogs with television programs highlighting product features.

The increasing use of wide area networks, such as the Internet, has resulted in an explosion in the provision of on-line services. Computer users can access a vast wealth of information and services by utilizing a wide area network to establish a connection with other computers connected to the network. Indeed, the Internet has quickly become a means for not only obtaining information, but for conducting commercial transactions and retail purchases.

The Internet is a global network of millions of computers belonging to various commercial and non-profit entities such as corporations, universities, and research organizations. The computer networks of the Internet are connected by gateways that handle data transfer and conversion of messages from a sending network to the protocols used by a receiving network. The Internet's collection of networks and gateways use the TCP/IP protocol. TCP/IP is an acronym for Transmission Control Protocol/nternet Protocol, a software protocol developed by the Department of Defense.

Typically, the computers connected to a wide area network such as the Internet are identified as either servers or clients. A server is a computer that stores files that are available to other computers connected to the network. A client is a computer connected to the network that accesses the files and other resources provided by a server. To obtain information from a server, a client computer makes a request for a file or information located on the server using a specified protocol. Upon receipt of a properly formatted request, the server downloads the file to the client computer.

The World Wide Web is a system of Internet servers using specified Internet protocols and supporting specially formatted documents. The Hyper Text Transfer Protocol (“HTTP”) is the underlying protocol used by the World Wide Web. HTTP defines how messages are formatted and transmitted, and what actions Web servers and browsers should take in response to various commands. The other main standard of the World Wide Web is Hyper-Text Markup Language (“HTML”), which covers how documents and files are formatted and displayed. HTML supports links to other documents, as well as graphics, audio, and video files.

Users access the content contained on the Internet and the World Wide Web with an Internet Browser, which is a software application used to locate and display web pages. A Web page is a document on the World Wide Web. Every Web page or file on a web server is identified by a unique Uniform Resource Locator. A Uniform Resource Locator (“URL”) is the global address of files and other resources on the Internet. The address indicates the protocol being used and specifies the IP address or the domain name where the file or resource is located. Typically, a URL identifies the name of the server and the path to a desired file on the server. For example, a URL for a particular file on a web server may be constructed as follows:

“http://<server>/<filepath>”, where <server> identifies the server on which the file is located and <filepath> identifies the path to the file on the server. Thus, with the name of the server and the correct path to a file, a properly formatted URL accesses a desired file on a server connected to the World Wide Web.

Electronic networks, like the Internet, allow consumers to visit various merchant web sites. Once at such a merchant web site, a user typically browses through an electronic catalog to find products of interest. On-line merchants employ a wide variety of ordering, payment and fulfillment systems in their “virtual” stores. For example, U.S. Pat. No. 5,825,881 teaches an on-line merchandising system whereby users add desired items to a virtual shopping cart during the shopping session.

Although traditional mail order and on-line shopping benefits consumers through easy access, detailed product information, more efficient transaction methods, and often cheaper prices, the shopping experience is abstracted from the traditional reality of being in the store and physically inspecting the products to browsing through catalogs often only containing one view of a particular product of interest. Moreover, consumers miss out on the actual “shopping experience” as they cannot see the actual store or store displays, closely inspect the products and compare them to adjacent, competing products. Furthermore, mail order and on-line catalogs typically do not allow the merchant to take advantage of the investments made in the appearance and product displays located in the actual retail or sales space.

Accordingly, a need exists for a method and system that provides the advantages of an on-line or virtual store, while providing consumers the experience of being in an actual store. The present invention substantially fulfills this need.

### SUMMARY OF THE INVENTION

The present invention provides methods and systems for real-time shopping in a remote physical location over a computer network. The present invention integrates so-called “telepresence” systems with on-line, electronic commerce and merchandising systems to achieve a novel, real-time shopping experience. Unlike conventional on-line catalogs, the present invention allows the user to visually navigate in real-time within an actual, physical space in order to view physical objects located therein, and to select or identify such objects for purchase or further inspection. Users navigate through the physical space by viewing images captured by cameras located within the space and remotely controlling the cameras by means of a user interface to capture more images of other selected regions within the space. According to the invention, the user interface of the present invention allows the user to identify or select viewed objects for purchase or further inquiry.

The present invention provides users with a rich, interactive shopping experience during which users can quickly switch between an information-based catalog and live views of an actual retail or sales space. The present invention, therefore, preserves the convenience of on-line or mail order shopping, while approximating the experience of shopping in an actual store. On-line shoppers can see real product displays, experience the atmosphere of the store, directly compare similar or competing products, as well as perform electronic searches for products and related information.

In its main aspect, the present invention provides a system for shopping in a remote physical location over a computer network comprising a user interface, that transmits control signals designating selected regions of the physical location, and displays images received over the computer network; and an image acquisition system that transmits an image of a selected region in the remote physical location in response to the control signals. According to the invention, the user interface allows a user of the system to select a product based on the image received and displayed by the user interface.

In one embodiment, the system of the present invention further comprises a product database including a list of products and regions in the remote physical location corresponding to those products, and a processor operably coupled to the database. The processor is also coupled to the computer network to receive a designation of a selected region from a user. The processor is programmed to access the database according to the selected region to retrieve the products corresponding to the selected region and to transmit data relating to the retrieved products to the user. In one embodiment, the regions stored in the database are defined in relation to the positional parameters of the image acquisition system.

Another aspect of the present invention includes an apparatus for shopping in a remote physical location over a computer network comprising a server operably coupled to the computer network to receive requests from users, and an image acquisition system operably coupled to the server. The image acquisition system captures images of selected regions in the remote physical location in response to control signals from the server and transmits the captured image to the server. According to the invention, the server, in response to a request from a user, sends control signals to the image acquisition system and receives an image of a selected region in the remote physical location. The server then transmits interface data including the image to the user. In one embodiment, the server adds the image to an interface template and transmits the resulting interface data to the user. The interface allows the user to select a product appearing in the displayed image. In one embodiment, the interface includes controls that allow the user to remotely control the image acquisition system via the server. In addition, other embodiments include a product database operably coupled to the server. The product database includes product identifications and product information for corresponding ones of said product identifications. The server, in response to a request from a user containing a product identification, accesses the product database according to the product identification to retrieve the corresponding product information.

The present invention also provides an apparatus for shopping in a remote physical location over a computer network comprising a database having a list of products located in the remote physical location and including regions in the remote physical location for corresponding ones of the products. The apparatus further includes a processor coupled to the database and also coupled to the computer network to receive a request from a user that includes a selected region in the physical location. According to the invention, the processor accesses the database according to the selected region to retrieve the products corresponding to and located in the selected region.

The present invention further provides a method for shopping in a remote physical location over a computer network. The method contemplates at least one client computer associated with one or more users, and at least one server associated with a provider of goods or services, all of which are connected to a computer network. According to the invention, the server is also coupled to an image acquisition system located in the remote physical location. The method comprises the steps of (a) receiving, at a server, a request from a user; the request including a designation of a selected region in the remote physical location; (b) acquiring an image of the selected region from the image acquisition system; and (c) transmitting interface data to the user, wherein the interface data includes the image of the selected region. According to the invention, the interface data also allows the user to select a product located in the selected region.

In one embodiment, the method further contemplates a database operably coupled to the server. The database, as above, stores a list of products located at the remote physical location and further stores regions in the remote physical location for corresponding ones of the products. The method comprises the steps of (a) receiving, at the server, a request from a user; the request including a designation of a selected region in the remote physical location; (b) acquiring an image of the selected region from the image acquisition system; (c) accessing the database to retrieve a list of products associated with the selected region; and (d) transmitting interface data, including the image and the list of products, to the user.

According to the method provided above, a merchant site prepares the physical location for remote on-line shopping and constructs the database by (a) placing a product in a selected region of the remote physical location; (b) associating the selected region with at least one positional parameter of the image acquisition system; and (c) storing the positional parameters corresponding to the selected region in the database in association with the product. In one embodiment, the image acquisition system comprises a computer-controlled camera wherein the positional parameters of the camera include pan, tilt and zoom. According to this embodiment, the selected regions in the remote physical location are defined by at least one of the pan, tilt and zoom parameters of the camera.

Other embodiments of the present invention analyze the image captured by the image acquisition to isolate and recognize tags or other identifiers that are associated with products appearing in the image. The method according to this embodiment comprises the steps of (a) placing a product in a selected region of the remote physical location; (b) placing a product identification tag on the product; (c) associating the tag with the product; and (d) storing a representation of the tag in the database in association with the product. Therefore, when an image is acquired, the server scans the image to identify the tag(s) placed on any product(s) located therein. More specifically, the tags captured in the image are recognized by processing the image to interpret image pixels as a tag. Suitable image processing techniques include object-character recognition, color region codes. It then accesses the database to retrieve the products associated with the tag(s) contained in the image. The server transmits interface data, including the image and a list of retrieved products to the user. In one embodiment, the server adds the image and a list of products to an interface document and transmits the interface to a user of the system.

Another method according to the invention uses the system of the present invention to generate a more traditional on-line catalog using images of an actual retail space or other remote physical location. The method comprises the steps of (a) receiving, at the server, a request from a user, the request including a selected region in the remote physical location; (b) transmitting, to the image acquisition system, control signals designating the selected region in the remote physical location; (c) receiving, at the server, an image from the image acquisition system; (d) storing the image in a database; (e) repeating steps (a)-(d) a desired number of times. According to the invention, at least one of the images stored in step (d) is added to a page or document stored in the server connected to the computer network.

As used herein, “remote physical location” refers to an actual physical space or location remote from the user. It is remote only in the sense that it is perceived through a user interface displayed on a computer screen or other suitable device. Accordingly, a remote physical location can include within its bounds a user of the system.

“Telepresence” refers to techniques and systems for acquiring, processing and delivering live, interactively-controlled, digital video and/or still images of a remote physical location over a computer network. Typically, visual telepresence systems involve the use of computer-controlled camera systems which are controlled remotely by users across a computer network. Users aim the camera by adjusting the pan, tilt and zoom to select regions of interest in a remote physical location. Many conventional telepresence systems allow multiple users to share control of a live video source. Typically, telepresence gives every user the feeling of independent control of the image acquisition system, even though other users are concurrently using the system.

As used herein, “real-time” refers to an interactive user experience in which the server transmits video or still images within seconds of the user's request.

### DESCRIPTION OF THE DRAWINGS

FIG. 1 is a functional block diagram illustrating the system of the present invention as applied to a computer network.

FIG. 2 is a flow-chart diagram illustrating a method according to the present invention.

FIG. 3 illustrates a first user interface according to the present invention.

FIG. 4 illustrates a second user interface according to the present invention.

FIG. 5 provides a third user interface adapted for use in the auction context.

FIG. 6 is a functional block diagram setting forth a second embodiment of the system of the present invention.

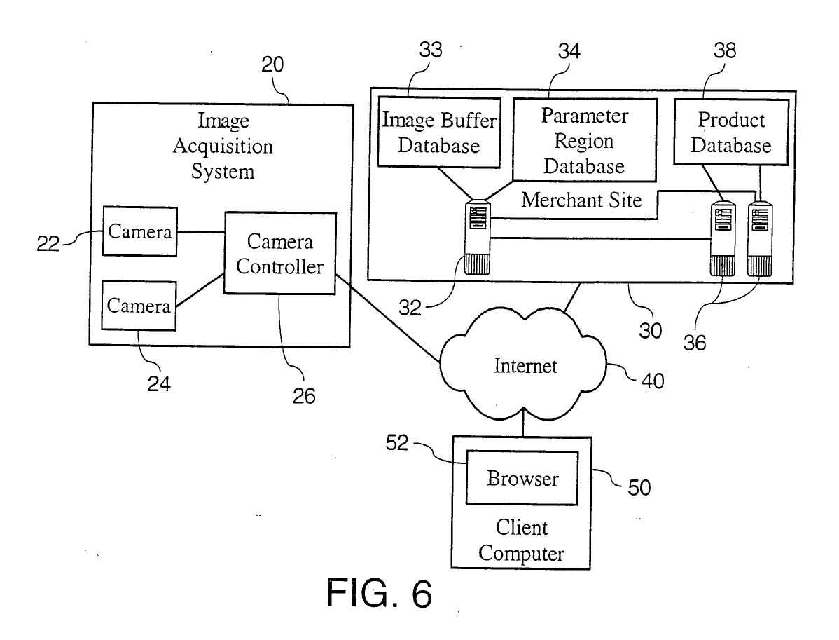

FIG. 7 is a functional block diagram showing a third embodiment of the system of the present invention.

FIG. 8 is a perspective view of a remote physical location according to an embodiment of the present invention.

FIG. 9 is a flow-chart diagram illustrating a method used in the present invention.

FIG. 10 is a flow-chart diagram illustrating a method according to the present invention.

### DETAILED DESCRIPTION OF THE INVENTION

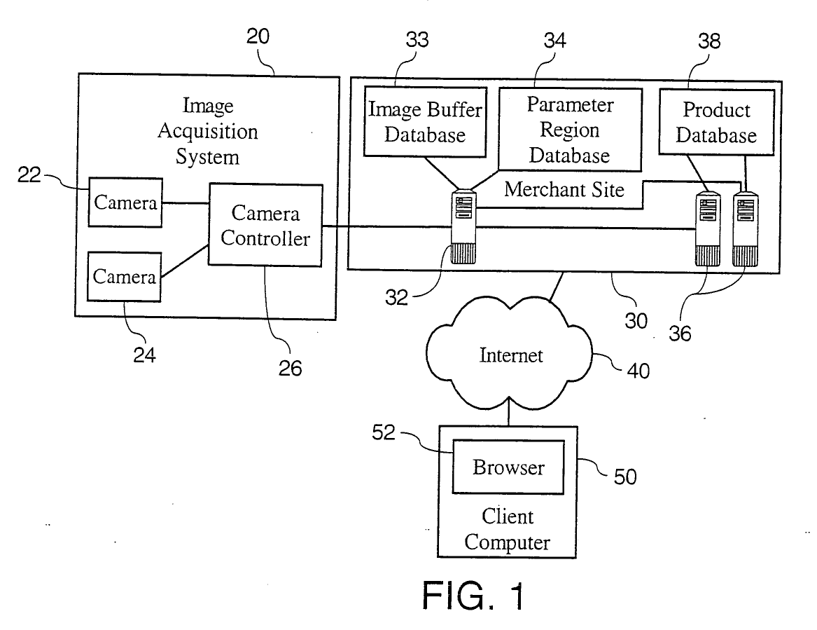

FIG. 1 shows an embodiment of the system of the present invention. The present invention generally involves at least one client computer 50 and at least one merchant or web site 30, both of which are connected to the Internet 40. Of course, one skilled in the art will recognize that the present invention can be applied across any computer network. Furthermore, the computer network can be any suitable computer network, including but not limited to, a wireless computer network, an electronic network, and an optical network.

As is conventional, merchant or web site 30 is supported by web or Internet servers 36, which receive requests submitted by users and transmit files and other documents in return. Servers 36 are conventional e-commerce servers connected to product database 38 allowing users to browse product catalog databases and purchase products, and handling electronic purchasing and fulfillment, as is conventional. According to the first embodiment of the present invention, merchant site further includes image server 32 and, optionally, image buffer database 33 and parameter region database 34. According to the invention, image server 32 is operably connected to image acquisition system 20. One skilled in the art will recognize from the description provided below that the division of functionality between servers 32 and 36 is not required by any constraint and that all the functions performed by servers 32 and 36 may be performed on one server.

Parameter region database 34, image buffer database 33 and product database 38 can be any form of database known in the art (for example, a relational database or flat-file database). In one embodiment, each database has associated therewith a collection of computer programs enabling the storage, modification, and extraction of information in the database. The databases may be stored on any suitable device ranging from personal computers (for small systems) to mainframes (for large systems). In addition, the functionality of servers 32 and 36 may be implemented in hardware or software, or a combination of both. In one embodiment, each server is a programmable computer executing computer programs, comprising at least one processor, a data storage system (including volatile and non-volatile media), at least one input device, and at least one output device. In addition, as one skilled in the art will recognize, the databases described above may reside on image server 32 or web server 36, or may be physically separate, but operably connected thereto.

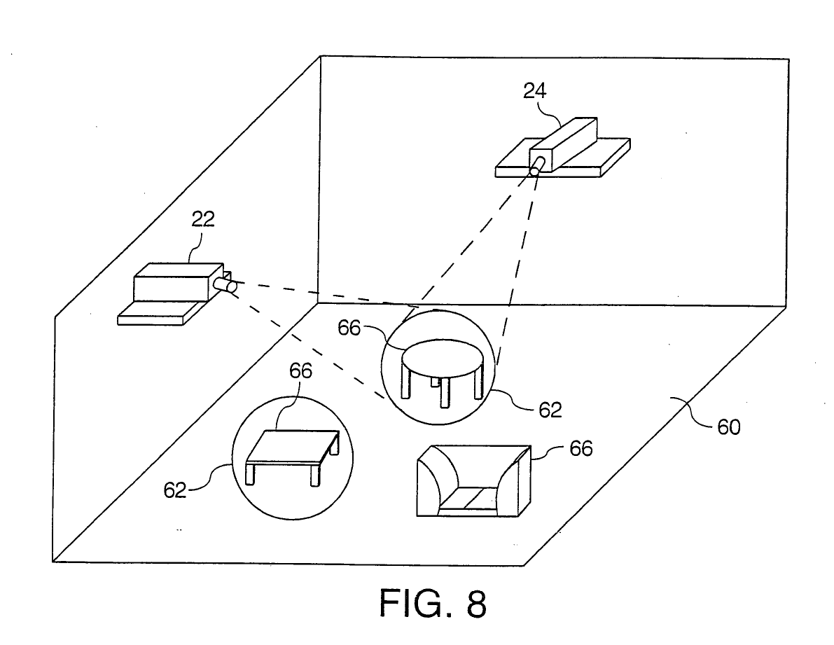

As FIGS. 1 and 8 illustrate, in the first embodiment, image acquisition system 20 comprises cameras 22 and 24 operably coupled to and controlled by camera controller 26. Cameras 22 and 24 capture images of selected regions 62 in remote physical location 60. (See FIG. 8.) Of course, any number and combination of cameras and device controllers may be used. In addition, one skilled in the art will recognize that the image capture, control and compression functionality of camera controller 26 may be embedded in cameras 22 and 24. In one embodiment, however, camera controller 26 receives control signals from server 32 designating regions of physical location 60. Camera controller 26, in response to such control signals, selects a camera, changes the position (pan and tilt, for example) and magnification (zoom) of the selected camera such that it captures the desired image of the selected region 62. A user, at client computer 50, may select regions 62 in physical location 60 containing products 66.

A variety of communication paths between camera controller 26 and image server 32 are possible. As FIG. 1 illustrates, camera controller 26 can be directly connected to server 32.

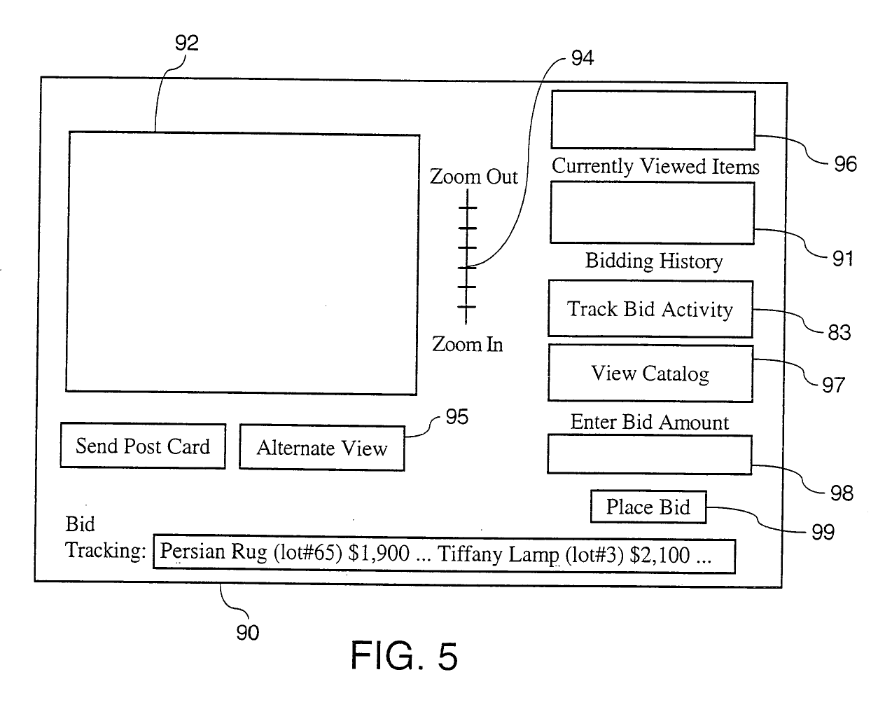

Such a connection could also occur via a local area network (LAN) or a wireless communication system. Alternatively, as FIG. 5 illustrates, communication between camera controller 26 and server 32 can occur via the Internet 40 or other wide-area network.

In one embodiment, cameras 22 and 24 are computer-controlled cameras, whose pan, tilt (angular positions) and zoom settings are controlled and adjusted electro-mechanically by servo motors, as is conventional. In addition, cameras 22 and 24 could be movably mounted on tracks located within physical location 60. Their position on the track could be similarly controlled by servo motors. Cameras 22 and 24 can be video cameras or still cameras. In addition, cameras 22 and 24 can be analog cameras, whose signal is digitized by a conventional frame-grabber. Cameras 22 and 24 can also be digital cameras, or any other suitable camera system. In the first embodiment, cameras 22 and 24 are analog cameras that take still images. According to this embodiment, camera controller 26 includes a frame-grabber board or other suitable device for digitizing the camera signal. According to one embodiment, camera controller 26 converts the resulting image into a JPEG or GIF (or any other suitable format) image file before it is transmitted to image server 32.

As one skilled in the art will recognize, currently available telepresence systems of widely varying configurations may be employed in the present invention. For example, other embodiments of the present invention may employ cameras having a fixed angular position with wide-angle view systems (including parabolic or “fish eye” lenses) such that displacement of the camera in the pan and tilt directions are unnecessary to capture images of the entire physical location. Still further, the image acquisition system may include an array of cameras extending radially from a common point in combination with software to stitch the resulting images together, as offered by Infinite Pictures Corporation as part of its “SmoothMove” Technology. Other suitable camera systems include a fish eye lens and de-warping and spherical viewing image processing software, such as that disclosed in U.S. Pat. No. Re. 36,207. Other suitable systems may include a camera system using a convex mirror disclosed in U.S. Pat. No. 5,760,826.

According to one embodiment of the present invention, remote physical location 60 is a retail space containing products 66. In one form, physical location 60 is a conventional retail showroom. In this manner, the present invention allows a retailer to extend its investment in the appearance of a retail space to the virtual world. In addition, remote physical location 60 may be any retail, wholesale, or pre-owned sales space, auction space or lot. Still further, physical location 60 may be a specialized showroom including products from more than one vendor. In addition, physical location 60 may comprise two or more separate retail spaces, each having image acquisition systems located therein.

As FIG. 1 shows, one embodiment of the present invention works in conjunction with a conventional computer 50 having an Internet browser 52 and a connection to the Internet. The user's computer 50 can be any computer, special-purpose computing device, or any other suitable device for performing the required functionality. In one embodiment, user computer 50 includes at least one processor, a data storage system (including volatile and non-volatile media), a keyboard, a display, at least one input device and at least one output device. In one embodiment, the user's computer is connected to the Internet via a modem dial-up connection or through a network line. Such communication, however, could also be wireless. In addition, although embodiments of the system are described as working in conjunction with a browser, any suitable device or application for receiving, displaying and transmitting data over a computer network can be used with the present invention.

### Operation

In use, a user at client computer 50 accesses merchant site 30 using browser 52 or any other suitable application. As is conventional, web server 36 receives a request from client computer 50 and transmits data in response. According to one embodiment of the present invention, the home page corresponding to merchant site 30 provides the user the option to browse a traditional on-line catalog or to navigate through an actual retail space where products are displayed. If the user selects the latter option, web server 36 transfers the user's request to server 32. In one form, each page of the conventional on-line catalog contains a hyper-link to a page providing a live view of the product in an actual retail space. As more fully discussed below, the page containing the live image of a product includes a hyper-link to the corresponding on-line catalog entry. In one form, the hyper-link, when clicked, causes browser 52 to construct a URL that includes the positional parameters required to direct the camera to the product, as is more fully discussed below. This configuration allows the user to seamlessly navigate between a traditional on-line catalog and live views of an product in a remote physical location.

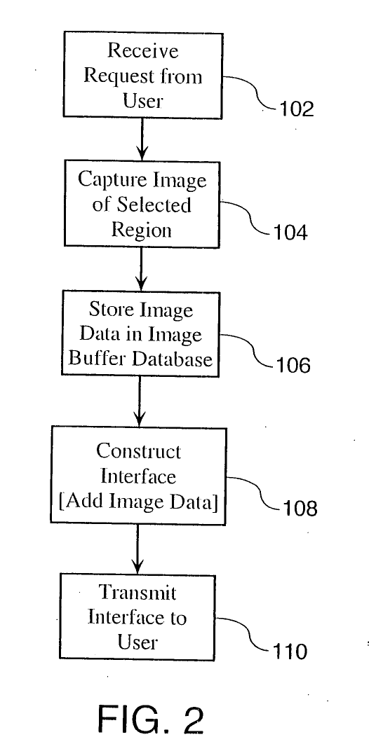

When a user request comes to server 32 (FIG. 2, step 102), server 32 directs image acquisition system 20 to capture a new picture (image) of a selected region 62 in physical location 60 (step 104). (See also FIG. 8.) In one embodiment, the first image taken and ultimately transmitted to the user is taken from a so-called default camera oriented at default pan, tilt and zoom values. This “default” image typically provides a user a view of the entire retail space. As discussed above, camera controller 26 moves the selected camera 22 (for example) to the default positional parameter values (pan, tilt, and zoom, in one embodiment) and causes camera 22 to take a live picture. In one embodiment, camera controller 26 includes a conventional frame grabber, which digitizes the image. Camera controller 26 further converts the digitized image into a JPEG image file (or any other suitable image file format) and transmits the image file to server 32. In one embodiment, server 32 stores the file in an image buffer database 33 (step 106). In one form, the positional parameters of the camera (pan, tilt and zoom values) are encoded into the file name pointing to the stored image file. Other parameters, such as the time at which the image was taken, may be encoded in the file name, as well.

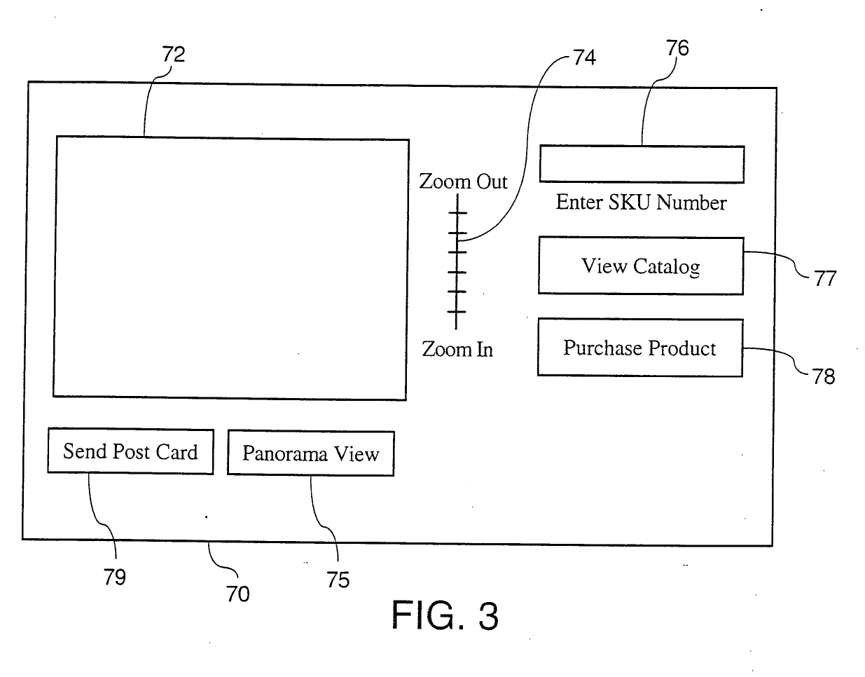

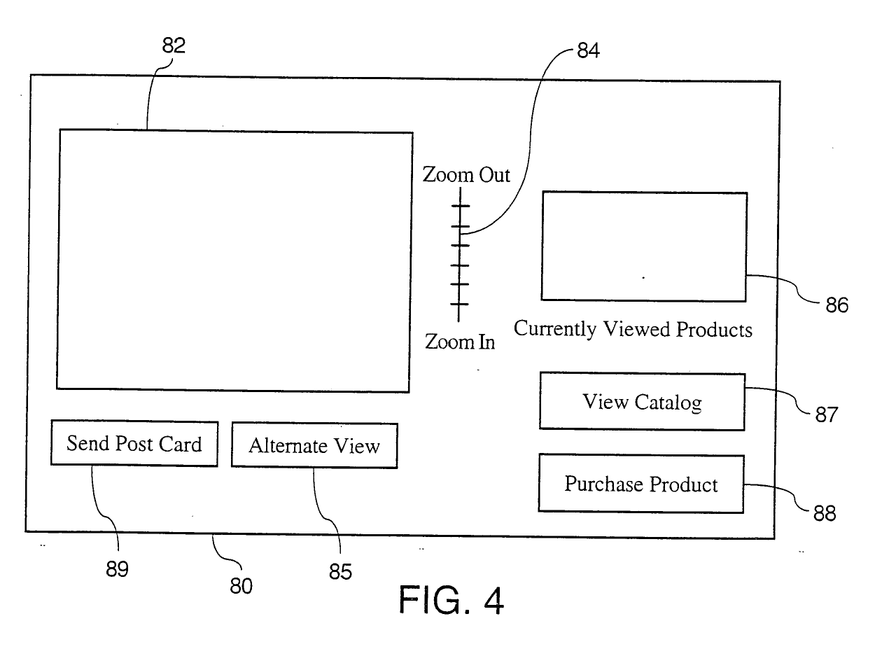

According to the invention, server 32 transmits interface data to the user including the image of the selected region in physical location 60. In one embodiment, server 32 constructs a user interface (see, e.g., FIGS. 3 and 4) which includes the requested image (step 108) and transmits the interface to client computer 50. In one embodiment, the user interface is a page-based interface. More specifically, and according to this embodiment of the present invention, server 32 stores a page-based interface template containing certain tags, which are replaced with data, program code, and/or pointers to files, before the resulting page (interface data) is transmitted to the user. In one embodiment using HTML pages, to construct the page-based interface, server 32 replaces a tag reserved for the image with code that creates an HTML form containing the requested image as a standard HTML image map. In one form, the form code contains a file name pointing to the requested JPEG image file (or other suitable format) stored in image buffer database 33. Accordingly, the image map, after the page has been transmitted to client computer 50 (step 110), allows the user to click in the image 72 (FIG. 3) of interface 70 to submit a request for live image of a new selected region 62 in physical location 60. In one form, the x- and y-coordinates corresponding to the point in the HTML image map at which the click occurred are transmitted to server 32 as part of a URL, constructed by browser 52, that also contains the pan, tilt, zoom and other camera parameters corresponding to the old image, contained in the HTML document as hidden fields. Using the old image parameters and the x- and y-coordinates of the image map, server 32 determines which one of cameras 22 and 24 (if more than one exist) to move and the positional parameters (pan, tilt and zoom values, in one embodiment) of such move necessary to capture an image of the selected region. Accordingly, the interface described in this embodiment allows the user to visually navigate through remote physical location 60 simply by clicking in the displayed image.

Additionally, the use of page-based interfaces is desirable since such interfaces work on most browsers. However, the interface may also be provided on the user's computer via a Java applet or a client-side plug-in which the user downloads prior to using the system. In these embodiments, servers 32 and 36 transmit interface data (such as image data and product data) which the applet or plug-in receives and displays on the user interface appearing on the user's computer. The interface may also be provided by a separate, special purpose application, which operates independently of a browser. Additionally, the present invention may work in conjunction with a special purpose kiosk or WebTV player. In addition, one skilled in the art will recognize that the server need not store the image file in image buffer database 33, but may transmit it directly to the user.

In yet other embodiments, the interface can be configured to allow the user to select a region in the physical location by designating an area in the displayed image, rather than just clicking at a particular point in the image. In one embodiment, the user may designate such an area by clicking in the image and dragging to create a box as is commonly found in many software applications. The interface then returns the coordinates of the box, rather than the x,y-point of the click, as described above, in order to request the image of the selected region.

FIG. 3 shows an interface according to the present invention. As FIG. 3 illustrates, interface 70 includes image window 72 and various interface controls. Interface controls include camera zoom control 74, panorama view button 75, product identification field 76, product information button 77, and product purchase button 78. As alluded to above in the description of one embodiment, a digital representation of the captured image is added as an image map to interface 70 at image window 72. As described above, interface 70 allows the user to navigate through physical location 60 by transmitting requests to server 32 which points cameras 22 and 24 to selected regions of physical location 60. As FIG. 3 indicates, certain embodiments provide the user the ability to control the zoom or magnification of cameras 22 and 24. More specifically, interface 70 includes zoom control 74 offering various zoom values. To select a zoom value, the user simply clicks on the provided cross-hatches and selects a point in the image to which he or she wishes to zoom, as is conventional. In one form, the user interface also includes a panoramic view to enhance the user's ability to navigate within a physical space. More specifically, panorama view button 75, when clicked, presents the user with a panoramic view of remote physical location 60. As with image window 72, the user may click in the image of the panoramic view to aim image acquisition system 20 at a new selected region. The new image is added to the interface template at image window 72 and transmitted to the user as discussed above. In this manner, the user may quickly navigate to other regions of physical location 60, even though the currently viewed image is zoomed in on a small region in physical location 60.

According to the invention, the user interface allows the user to identify products in the current selected region and request further action with respect to them. In one embodiment, the user interface includes vendor or merchant contact information, such as a telephone number or e-mail address, which the user may use to contact the merchant or vendor. Under this embodiment, the user navigates within the physical location in order to see images that are sufficiently detailed to adequately identify the products in them. For example, and in one embodiment, each product includes a tag displaying a product identification, such as a number or name. According to this embodiment, the user navigates the camera and uses the zoom control to capture an image sufficiently large to be able to read the product identification. The user then contacts the merchant using the phone number or e-mail address displayed by the interface and, using the product identification, orders the product or requests more information with respect to it.

Alternatively, and according to one embodiment, the user interface itself includes a product identification field, such as field 76 of interface 70. According to this embodiment, each product in physical location 60 includes a tag containing a unique number or other product identification. The user uses the interface controls described above to navigate within physical location 60 and inspect various products 66. When the user wishes to purchase a particular product or to receive more information about it, he navigates a camera to the product such that an image of the product and the identification tag is captured. When the user receives the requested image, he enters the product identification into product identification field 76. As FIG. 3 indicates, if the user wishes to purchase the product, the user clicks on the “purchase product” button 78. If the user desires more information about the product, he clicks on “View Catalog” button 77. In either case, the user is then transferred back to a conventional on-line shopping or e-commerce engine on web servers 36 accessing product database 38 to either browse the catalog entry of the selected product or to purchase the product. In one embodiment, servers 36 access product database 38 to determine the availability of the product(s) selected by the user. Such availability information can include the availability of certain sizes or colors in which the product(s) is (are) offered, if applicable.

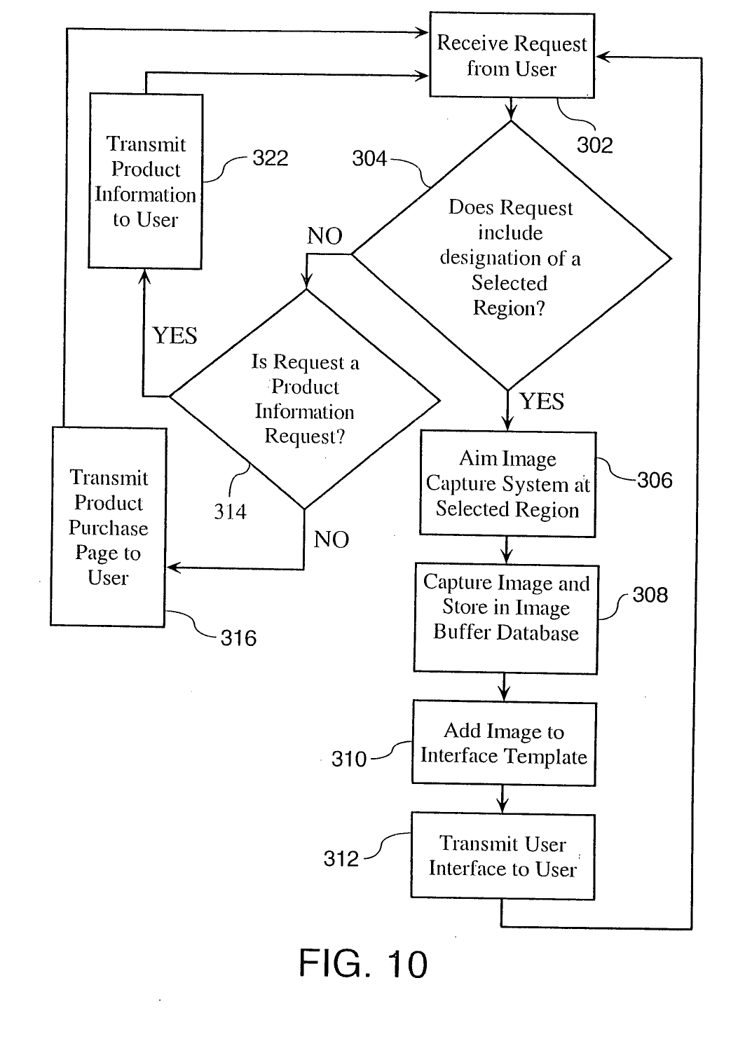

FIG. 10 shows a method for processing user requests associated with interfaces 70 and 80 as illustrated in FIGS. 3 and 4, respectively. According to this embodiment, a request for a new image is received from a user (steps 302 and 304). Server 32 aims image acquisition system 20, as discussed above, according to the image parameters received with the user's request (step 306). The image is added to an interface and transmitted to the user (steps 308-312). However, if the user's request includes a product information request, then server 32 accesses product database via servers 36 and transmits related information to the user (steps 314 and 322). Lastly, if the user's request includes a product purchase request, then a purchase order form is transmitted to the user (step 316).

In addition, interface 70 includes a “Send Post Card” button 79. A user may invoke this option to send a JPEG image file of the current view in image window 72 as an e-mail attachment. Alternatively, this “post card” image could be sent to a sales representative affiliated with merchant site 30 as part of a request for a price or more information. The sales representative responds to the post card by sending a catalog entry, for example, or a price for the pictured item.

A related aspect of the present invention includes the generation of a digital receipt incorporating a digital image file of a purchased product. More specifically, after a user purchases a product, server 32 constructs a digital receipt comprising data relating to the details of the transaction (date, time, price, quantity, payment information, etc.) and a digital image file of the purchased product as captured by image acquisition system 20. In one form, this receipt includes a 25, digital signature using the merchant site's private key. This signed digital receipt can then be e-mailed to the purchaser as a confirmation of his or her purchase.

FIG. 4 provides an alternate interface according to the present invention. As FIG. 4 shows, interface 80 includes “Currently Viewed Products” field 86 containing a list of the products appearing in the selected region 62 currently displayed in image window 82. In one embodiment, the list of products contains hyper-links to pages in web server 36 that contain purchase order forms. According to this embodiment of the present invention, the interface template stored in server 32 includes another tag reserved for the list of products. When server 32 constructs interface 80, server 32 performs the additional step of accessing parameter region database 34 and adding a list of products to interface 80, as more fully described below.

As FIG. 8 illustrates, a merchant places products 66 in various regions 62 of retail space 60. As one skilled in the art will recognize, a specific region 62 in physical location 60 can be defined according to the corresponding positional parameters (pan, tilt and zoom values, in one embodiment) of a camera located therein. (See FIG. 8.) According to this aspect of the invention, the pan, tilt and zoom values corresponding to the regions 62 in which a product or group of products is placed is stored in parameter region database 34 in association with the corresponding product. This process can be repeated for every product placed in physical location 60 and for each camera (if physical location 60 includes more than one camera). In an embodiment, products 66 stored in database 34 may be associated with a range of positional parameters corresponding to each camera.

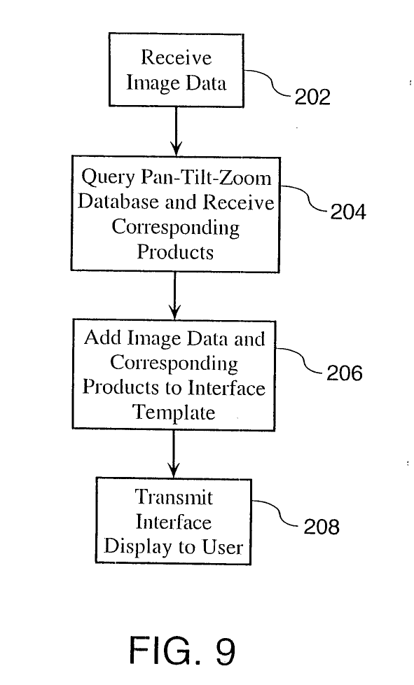

Therefore, as FIG. 9 illustrates, to complete interface 80, server 32 queries parameter region database 34 to retrieve a list of products located in the selected region (step 204). In one embodiment, server 32 replaces a tag in a page-based interface template (discussed above) with the list of retrieved products (step 206) and transmits interface 80 to the user (step 208).

As one skilled in the art will recognize, a software tool could be easily developed to facilitate the process of associating products with the regions in which they are placed. Such a software tool lets the merchant visually navigate a camera in a retail space, stop at a region in which a product has been placed, and enter the corresponding product identification. The interface to the tool may provide the current pan, tilt, zoom and region size values of the currently viewed image and enter such values in the database in association with the product identification.

In addition, the parameters that define a particular region will necessarily vary with the configuration of the image acquisition system. For example, the cameras employed may only be movable in the pan direction. Therefore, the region need not be defined by a tilt parameter since the tilt values will be the same for all images. Still further, a camera system movably mounted on a track, as described above, requires that the regions also be defined with respect to the camera systems position on the track.

Yet another embodiment for identifying products viewable in selected regions of the retail space 60 includes the use of identification tags. According to one version of this embodiment, objects in a showroom (physical location) are marked with unique color tags. The camera for use with this embodiment is a color video camera. Server 32 is programmed to scan the resulting image and recognize the color tags.

The tag system, in one embodiment, uses easily recognized geometric patterns in different colors to encode an identification number. Server 32 accesses a database having a list of products stored in association with corresponding ones of the identification numbers. The patterns can consist, for example, of a white background with a series colored circles in the foreground. The colors for use with the system are chosen so as to be easily distinguished (e.g. by using the extreme values in the color spectrum, excluding white and black). Accordingly, a pallette of six colors and a sequence of six circles allows for 6⁶ (over 46,000) unique identification numbers. Alternative embodiments, using only black and white, employ a form of bar code identification tag or use text recognition algorithms to identify products. In yet other embodiments, image acquisition system may further include a bar code reader mounted on a camera that reads bar codes appearing in the field of view as the camera captures an image of the selected region.

To enhance the on-line shopping experience, interface 80 further provides the user the option to view a selected region 62 and product(s) 66 contained therein from alternate viewpoints. One embodiment features the use of two cameras 22 and 24. (See FIG. 8.) Interface 80 includes “Alternate View” hypertext link 85 which causes server 32 to capture an image of the current selected region of physical location 60 from the viewpoint of an alternate camera. (See FIG. 4). Using the dimensions of the physical location, the locations of the cameras, and the orientation of the current camera, the positional parameters of the alternate camera required to capture the same selected region can be easily calculated using basic trigonometric principles. Therefore, if the current image of selected region 62 originated from camera 22, server 32 calculates the required positional parameters to capture an image of the same selected region from camera 24. Server 32 then transmits these parameters to device controller 26 which operates camera 24 accordingly.

Furthermore, it should also be noted that systems according to the present invention could combine different aspects of the product selection and identification techniques discussed above. In one embodiment, the positional parameters of the currently viewed image could be used to limit a search of a merchant's on-line catalog. For instance, the positional parameters of an image can be associated with a shelf or other space containing a group of products. Accordingly, a search of the merchant's on-line catalog could be limited to the group of products appearing in the image. Still further, the interface can display a list of the products as thumbnails images, and/or names and caption, with links to the on-line catalogue entries. In addition, other embodiments can account for potential inaccuracies in a tag recognition system. According to this embodiment, the server processes the image and produces a list of possible products based on similar looking tags, products currently in inventory and on that shelf which are known to be near it, products within the same category of the catalogue, the user's past browsing and buying history, and/or other related shoppers selections in this situation. Various algorithms combine the relevancy ratings of these factors to provide the user with a list of related products. One may even apply traditional information retrieval techniques to solve this problem (e.g. full-text search, indexing, relevance ratings, keyword stats analysis, etc). The key concept is that while the user navigates around the store, the system presents its best guess of what the user is viewing and the option to select one of the guesses.

As one will readily recognize, the present invention has application in a variety of sales contexts, including but not limited to, retail, real estate, trading, bartering, and wholesale sales. The present invention can also be easily applied to the auction context. FIG. 5 illustrates a user interface configured for the auction context. As discussed above, the user navigates within an auction space to view actual objects being auctioned by using zoom control 94 and/or clicking in image window 92. In this context, interface 90 includes a “Currently Viewed Items” field 96 which operates, as described above, to display a list of items appearing in the current selected region of the auction space. “Bidding History” field 91 displays the bidding history and current highest bid for each item appearing in the selected region. As FIG. 5 indicates, interface 90 provides the user the options to select an item in field 96 and 1) view a catalog entry by clicking on “View Catalog” button 97; 2) place a bid on the selected item by entering the bid in field 98 and clicking “Place Bid” button 99; or 3) track the bidding activity related to the item by clicking “Track Bid Activity” button 83. In one form, interface 90 further includes “Bid Tracking” field 93 which allows the user to track the bidding activity on the items selected by the user. In one embodiment, such bidding activity information continuously scrolls in field 93. In this manner, the user can monitor bidding activity and simultaneously navigate through the auction space in search of additional items.

According to one embodiment, the user before gaining access to the auction space provides certain payment information, such as credit card number, expiration date and delivery address. This information is stored and communicated with the user's bid. If the user's bid on a particular item is ultimately accepted, the user's credit card account is automatically billed and the item is sent to the user. As one can imagine, a wide range of features can be added. Interface 90 could also contain links to auction catalogue entries for related items or links to preset camera shots of other related items for auction. Interface 90 can also contain a chat window providing a discussion forum for the item currently being viewed by multiple users of the system. In addition, the user may configure a trigger that sends the user a live post card of a selected item if the bid price reaches a certain threshold amount. Still further, as one skilled in the art will recognize, the present invention also has application in so-called on-line “reverse” auctions described in U.S. Pat. No. 5,794,207 issued to Walker et al.

The present invention also allows for other innovative on-line shopping experiences, including a facility for on-line interaction among a plurality of users. For example, the present invention allows for on-line, collaborative product discussions among purchasers and sales staff. According to this aspect of the invention, the sales personnel can use the telepresence system to capture live images of products and to send them to purchasers via e-mail or as part of a live chat room discussion. In addition, an e-mail containing a link to a page having a live shot from a particular selected region could also be sent. Still further, the system may further include an interface intended for the merchant that shows multiple thumbnail views of the various images currently being viewed by users of the system. The interface also notifies the merchant when a particular user requests on-line sales assistance. The merchant, using the interface, identifies the product the user is viewing and sends a message to the user. A collaborative sales discussion ensues.

In addition, the present invention's use of real images allows for an enhanced visual “shopping cart” system. According to this aspect of the invention, as a user navigates through the retail space, various images are captured and stored as discussed above. When a user selects a product for purchase, the selected products are added to a virtual “shopping cart” as is conventional. As one skilled in the art will recognize the “Purchase Product” button 78 (see FIG. 3) can be an “Add to Cart” button. However, the shopping cart of the present invention is visual in that it contains thumbnail views of actual images of the selected products in the retail space as captured during the user's shopping session. In one embodiment, the user is presented with a live view of the product in the retail space, when he or she clicks on the thumbnail image of the product in the virtual, visual shopping cart. In other embodiments, the thumbnail image provides is linked to a detailed catalog entry.

According to another aspect of the invention, the system may also contain scripts providing a virtual live image tour of the retail space. Under this aspect of the present invention, server 32 steps image acquisition system 20 through a pre-determined series of shots in selected regions of physical location 60. In one form, after each image capture, the image is combined with a page template similar to that described above and transmitted to the user.

The system may also be used to remotely generate images of retail space 60 for use in a conventional on-line catalog. In fact, the present invention allows a web site administrator to add images of an actual retail store and to update the images without having to travel to the store itself. According to this embodiment, the site administrator directs cameras 22 and/or 24 via server 32 to take desired images of selected regions of the physical retail space. The images are stored as discussed above and can be subsequently used in a conventional on-line catalog.

With respect to the above-provided description, one skilled in the art will readily recognize that the present invention has application in a variety of contexts. The foregoing description illustrates the principles of the present invention and provides examples of its implementation. Accordingly, the description is not intended to limit the scope of the claims to the exact embodiments shown and described.

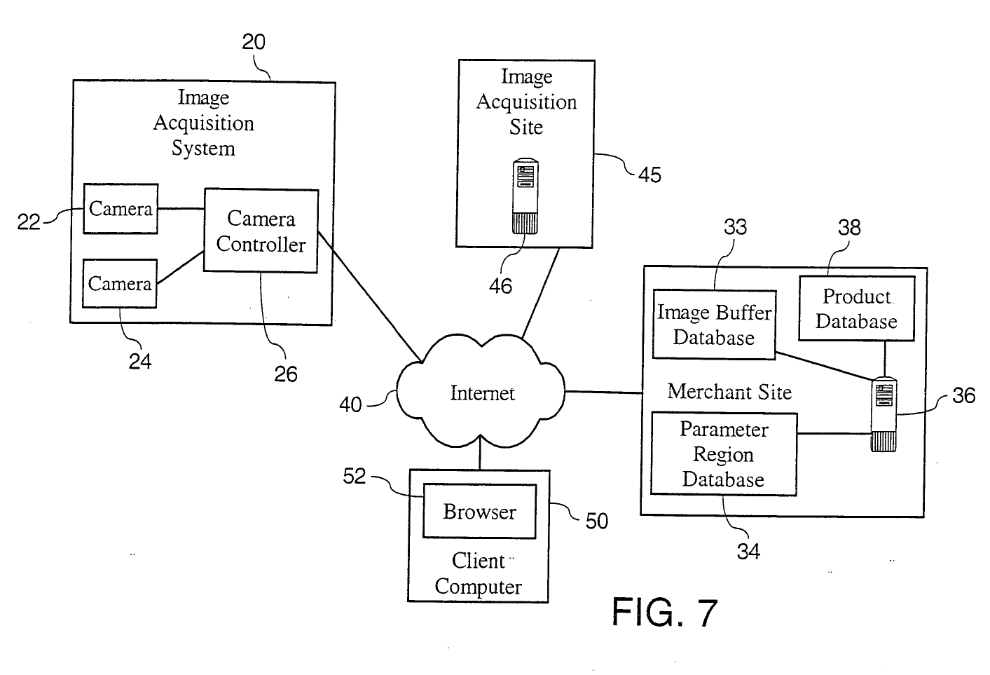

For example, as FIG. 7 demonstrates, the functionality of the image server could be supported by an entity separate from merchant site 30. More specifically, when a request from client computer 50 includes a live image request or parameters, server 36 of merchant site 30 accesses server 46 of image acquisition site 45 to retrieve the requested image. Image server 46 operates in conjunction with image acquisition system 20 as discussed above to generate the live image. Server 46 transmits a digital representation of the image to server 36 which constructs the interface and transmits the interface to the user, as discussed above.

1. A system for shopping in a remote physical location over a computer network comprising
a user interface, remote from said physical location and coupled to said computer network, said user interface transmitting control signals designating selected regions of said physical location, said user interface displaying images received over said computer network; and
an image acquisition system coupled to said computer network, said image acquisition system transmitting an image of a selected region in said remote physical location in response to said control signals;
wherein a user of said shopping system can select a product based on said image received and displayed by said user interface.

2. The system of claim 1 wherein said user interface includes a field into which said user may identify said product.

3. The system of claim 1 wherein said user interface includes a list of products appearing in the selected region displayed by said user interface.

4. The system of claim 1 wherein said user interface includes vendor contact information.

5. The system of claim 1 further comprising a parameter region database, wherein said parameter region database includes a list of products and regions in said remote physical location for corresponding ones of said products, and a processor coupled to said parameter region database, said processor also being coupled to receive a selected region, said processor accessing said parameter region database according to said selected region to retrieve the products corresponding to said selected region, said processor further being coupled to transmit said retrieved products to said user.

6. The system of claim 5 wherein said regions stored in said database are defined in relation to at least one positional parameter of said image acquisition system.

7. The system of claim 5 wherein said image acquisition system includes a camera system; and wherein said regions stored in said database are defined by at least one of the pan, tilt and zoom values of said camera system.

8. The system of claim 5 wherein said image acquisition system includes a camera system; and wherein said regions stored in said database are defined according to a range of pan, tilt and zoom values of said camera system.

9. The system of claims 5 wherein said user interface displays a list of said retrieved products.

10. The system of claim 9 wherein said list of retrieved products includes hyper-links.

11.-15. (canceled)

16. The system of claim 1 wherein said image acquisition system includes a camera system.

17. The system of claim 16 wherein said camera system includes at least one computer-controlled, pan-tilt-zoom camera.

18.-33. (canceled)

34. The system of claim 1 wherein said selected region contains at least one product.

35.-91. (canceled)

92. A method for shopping in a remote physical location over a computer network, said computer network carrying and routing data between computers connected thereto, said computers including at least one client computer associated with one or more users, at least one server associated with a provider of goods or services, said server coupled to a database, said database including a list of products located at said remote physical location, said server operably coupled to and controlling an image acquisition system, said method comprising the steps of
(a) placing a product in a selected region of said remote physical location;
(b) placing a product identification tag on said product;
(c) associating said tag with said product; and
(d) storing a representation of said tag in said database in association with said product.

93. The method of claim 92 further comprising the steps of
(e) acquiring an image of said selected region;
(f) analyzing, at said server, said image to identify said tag placed on said product;
(g) accessing said database according to said identified tag to retrieve said product identification.

94. The method of claim 93 further comprising the step of
(h) transmitting interface data to said user, said interface data including said image and said product identification.

95.-102. (canceled)
